(19) United States
(12) Patent Application Publication
(10) Pub. No.: US 2004/0007258 A1
(43) Pub. Date: Jan. 15, 2004

(54) Simple non-electric produce washer

(76) Inventors: Diane R. Lasker, Roseville, MI (US); Shirley A. Karfis, Dearborn Heights, MI (US)

Correspondence Address: Diane R. Lasker, 20317 Ellis St., Roseville, MI, 48066, US

(21) Appl. No.: 10/192,262

(22) Filed: Jul. 10, 2002

(51) Int. Cl. B08B 3/04

(52) U.S. Cl. 134/155; 134/157; 134/25.3

(57) ABSTRACT

This simple non-electric produce washer is a devise designed to dislodge and gently wash away unhealthy and often time's life threatening impurities from any number of fruits and vegetables without causing bruising or damage. The unit is designed for both residential and/or commercial use. Its unique design employs a non-electrical, three part system, which consists of a reservoir (4) for holding a continuous stream of water, a sieved basket (16), and a waste outlet.

### BACKGROUND

1. Field of Invention

This invention relates to a non-electric Produce Washer and its specific ability to thoroughly clean produce.

2. Description of Prior Art

Back in the good old days, some folk thought nothing of yanking, say a few radishes or carrots out of the ground, and then eating them as though they hadn't a care in the world. However, they might have felt differently had they only known that along with the carrots, for instance, they were more than likely ingesting a significant number of insects and their larva, bovine based fertilizers, and even bird and animal droppings. Yet, despite risking serious danger to their health, they continued the practice and even joked, “Hey, everybody knows, you have to eat at least a pound of dirt in your lifetime in order to stay healthy!”

Of course by today's standards, nothing could be further from the truth, and to even hint at such a thing would surely raise eyebrows within our present society. Still, while the old adage has since been proven to be totally unfounded, it isn't unusual to see people of today sampling unwashed produce at their local grocery stores. Perhaps because they feel invincible, and wonder why all the fuss over only a few measly grapes or cherries. On the other hand, some people are aware of the risks, but at the same time are naive enough to believe that the new overhead water sprayer systems now being installed in grocery store produce departments, are there to specifically wash away dirt, debris and any other unpleasantries from especially leafy vegetation. Naturally if that were so, such a service would be a blessing to homemakers and professional food handlers alike. Except, when viewed with a more cynical eye, it should be noted that the sprayer systems were only designed to freshen the produce, not clean it!

In the meantime, and especially since the post WW II population explosion, farmers had to figure out how to remain both competitive and fiscally sound, while at the same time increasing their yield per acre like never before. So, believing the rhetoric, they turned to what major chemical companies claimed were safe yet new and revolutionary ideas in farming. Mainly using ton upon ton of herbicides, pesticides, insecticides, and of course, old standbys like bovine-based fertilizers. Enough, some joked, to kill a horse! However, in retrospect, they might have not been so far from the truth because research has since proven their claims of complete safety otherwise. Take the DDT fiasco, for example, as it turned out it wasn't the miracle cure-all manufacturers claimed it would be. In fact, the scientific community has documented serious side effects in humans that not only created widespread medical dilemmas, but environmental ones as well.

On the other hand there is no question that these chemical substances are a necessity, since without them, farming, as we know it today would be absolutely devastated. Still, considering the age-old adage of eating a pound of dirt in order to stay healthy is nothing more than a myth and should be dispelled at once. But the public also has to use some common sense and be aware that chemicals can be just as lethal as dirt, otherwise they may risk serious health condition, and at the very least, long term side effects.

In fact, over the years people have learned a thing or two about both safe food handling and corporate rhetoric through a variety of ways. Take the Internet for instance, among other things Foodsafe archives at, //www.nal.usda.gov/foodborne., was created to educate the public on the importance of thoroughly cleaning produce before human consumption. But for those who don't have access to a computer, a long and reliable list of information is readily available, anywhere from newspaper and TV accounts, to doctorial papers and handout pamphlets from the FDA. Although unfortunately, some of the literature can be pretty hard to stomach, since after all it isn't pleasant thinking of bugs breeding and infesting lettuce leaves, microscopically small spiders crawling around bunches of celery, or toxic chemical residues. But perhaps the most thought provoking consideration may be the possibility that their produce was picked by field hands infected with hepatitis, or for that matter, any number of communicable diseases.

But besides green vegetation, consider the cantaloupe, its skin, or netting as it is called, is rough and porous. Therefore dirt and debris can become caked and deeply embedded in all its nooks and crannies. What's more, when a knife's blade pierces through its skin, it can easily drag in microscopic pathogens living within its netting. And again, other considerations are the pickers, field hands and handlers. If they are infected with any communicable disease, they risk contaminating not only lettuce and cantaloupe, but any other surrounding produce as well.

For those reasons alone, it is imperative to thoroughly wash even the smallest grape or leaf of lettuce before being consumed. However to some, the task is not only tedious, but time consuming as well. And right they are, because according to FDA guidelines, all unwashed produce must be placed into a large bowl of cold water, and then after soaking for a moment or two, dunked up and down and then swished around until all visible debris is loosened. Next, the guideline goes on, the produce is transferred to a colander where it is rinsed and re-rinsed under cold running water for several minutes, then left to drip dry.

This same dunk and swish method has been, and to this day is, the FDA's only recommended way to thoroughly clean all types of produce. It also clearly states, all fruits and vegetables should be washed in plain cold water. Nowhere in their literature is there mention of additives of any sort, and in fact, they advise against using soaps or detergents. But despite their advice, several well-known and respected corporations have contradicted their guidelines and have developed a formula they say is far better than just plain water. In fact, in recent advertisements their rhetoric claims to have more definitive answers to cleaning produce, than say the FDA. In effect they urge the public to simply purchase their kit containing a small plastic bowl, which by the way, most people already have in their homes, a plastic colander, also something most people already have in their homes, and a sprayer bottle full of even more chemicals. And while their product claims to be 98% effective in removing wax and chemicals off of produce, there is no mention of it being 100% safe. Nor does it mention two other serious possibilities; either allergic reaction to the chemicals within the spray bottle, or since the sprayer bottle is undated and with no storage recommendations, no guarantees that their formula isn't an ideal breeding ground for dangerous microorganisms. Although what the purchase of the kit does guarantee is, that aside from their liquid formula, people paid darned good money for utensils they already had, and for something that didn't make the task any faster or easier. In fact nothing changed. First, their kit didn't alter the time factor in the least, and second, it's still a manual process where hands get wet from the dunking and swishing process, and like always, messes are made. But despite the sameness, people have paid unnecessary dollars to get the exact same results the FDA has been recommending all along.

Which brings up attempts by others to automatically clean produce. Take for instance, U.S. Pat. No. 4,173,051 to Reid, Joyce P. (11/06/1979). As described, it appears to be of awesome size and cumbersome as well. It is a washer that houses a plurality of parts, a bristle impeller, blade impellers, turbine, and a shaft. However, Ms. Reid's drawings are not specific enough to determine whether or not these blades, impellers and turbine are motor, or water driven. But, if in fact her devise were water driven, the necessary water pressure would have to be of such extensive force, that standard household hook ups would be totally insufficient. Although, if in the event it is motor driven, the issue of safety is sure to come into play, since as everyone knows, water and electricity do not mix.

Also at issue is U.S. Pat. No. 4,236,541 to Cipriani, Tulio. (May 03, 1979), which also has several disadvantages. First, its complexity and second its motorized basket with various speeds set at levels likely to bruise and damage produce. But neither compares to the possibility of electrical shock, since once again, everyone knows water and electricity do not mix.

Lastly is U.S. Pat. No. 5,927,304 to Wen, Sheree H. (Jul. 27, 1999). It not only claims to use a light source within the container, but a wavelength of light capable of killing microorganisms. It also includes a reflective inner surface for increasing its light source, and mentions sonic vibrations, and transducers for generating acoustic energy. Which by the way, sounds far too complex for the average homemaker/professional food handler. So here again it should be noted that the afore-mentioned patents are electrically driven, and remember, as everyone knows water and electricity do not mix.

### SUMMARY INCLUDING OBJECTS AND ADVANTAGES

In accordance with our produce washer, a cylindrical shaped reservoir houses a water inlet coupling system, drain assemblage, and sieved basket. The unit is permanently attached to its base and connects to any standard water source, thereby creating a state of the art, non-electrical, produce washer.

### OBJECTS AND ADVANTAGES

Accordingly, the objects and advantages of our produce washer provides for an effective, yet simple means of thoroughly washing away dirt and debris from a vast variety of fresh fruits and vegetables. Furthermore, since the produce washer is non-electrical, and with no delicate parts to become broken or disarranged, its operation is extremely simple and effectual. -One of our produce washer's best advantages is its unique ability to adapt to either a smaller residential, or larger commercial version, and the fact it can be permanently installed. At the same time, all its variations are specifically designed for its ease of operation and effectiveness. Accordingly, its objective is three fold. First, its strategically angled water inlet coupling, allows for a continuous rush of incoming and ever changing water, which flows though the coupling assembly and into the reservoir, thereby creating the cyclonic action necessary to thoroughly cleanse all sorts and types of vegetation. And just as importantly, without bruising or marring. Secondly, as this continuous flux of clean, cold, tap water, reaches its designated fill level, these same waters automatically empty through the overflow drain assemblage, and down an adjacent sink. Thereby, preventing an overflow of the reservoir. Thirdly, since our produce washer steadfastly maintains its integrity by adhering to the FDA Guidelines for Safe Food Handling, the consumer not only gains peace of mind, but also precious time and effort.

Still further objects and advantages will become apparent from a consideration of the ensuing description and accompanying drawings.

### BRIEF DESCRIPTION OF THE DRAWINGS

FIG. 1 is a overview isometric drawing of the produce washer.

FIG. 2 is an isometric drawing, which depicts pivot point.

FIG. 3 is an isometric drawing which depicts a sieved basket and its lid.

### REFERENCE NUMERALS

4 Reservoir

6 Overflow Drain

8 Primary Drain

10 Waste Drain

12 Base

14 Water Inlet Coupling

16 Basket

18 A&B Basket Lid

20 Total Cover

21 Tethered cap

22 Roller

24 Pivot

26 A&B Lock

28 Handle Guide

30 Standard Water Adapter (not shown)

### PREFERRED EMBODIMENT—DESCRIPTION

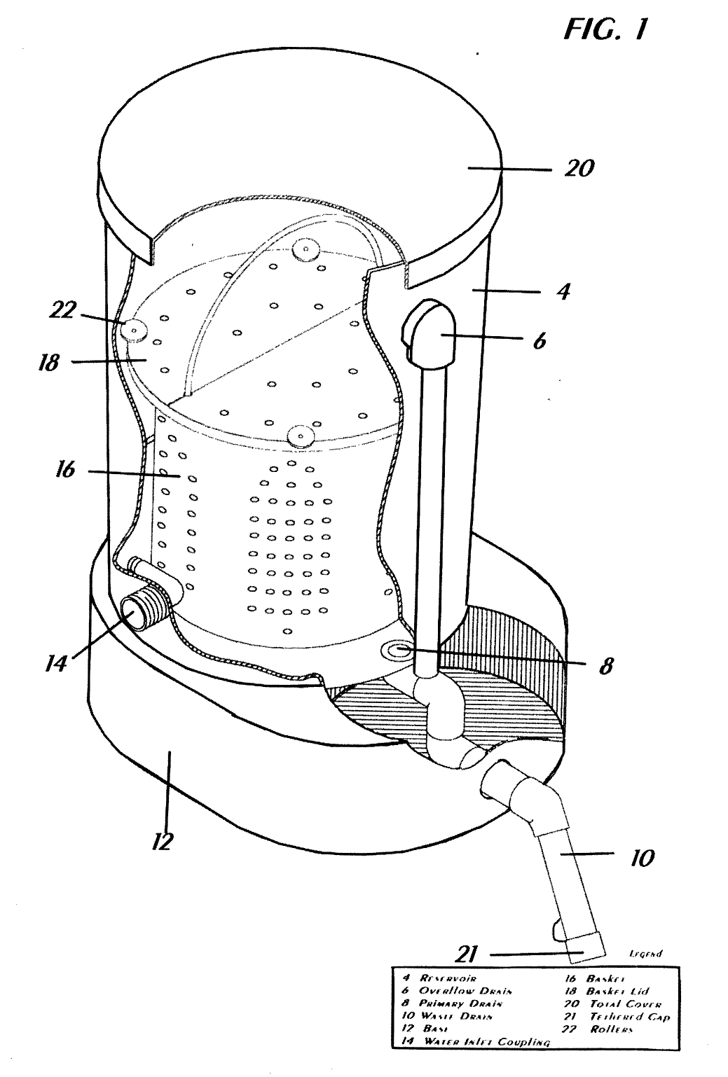

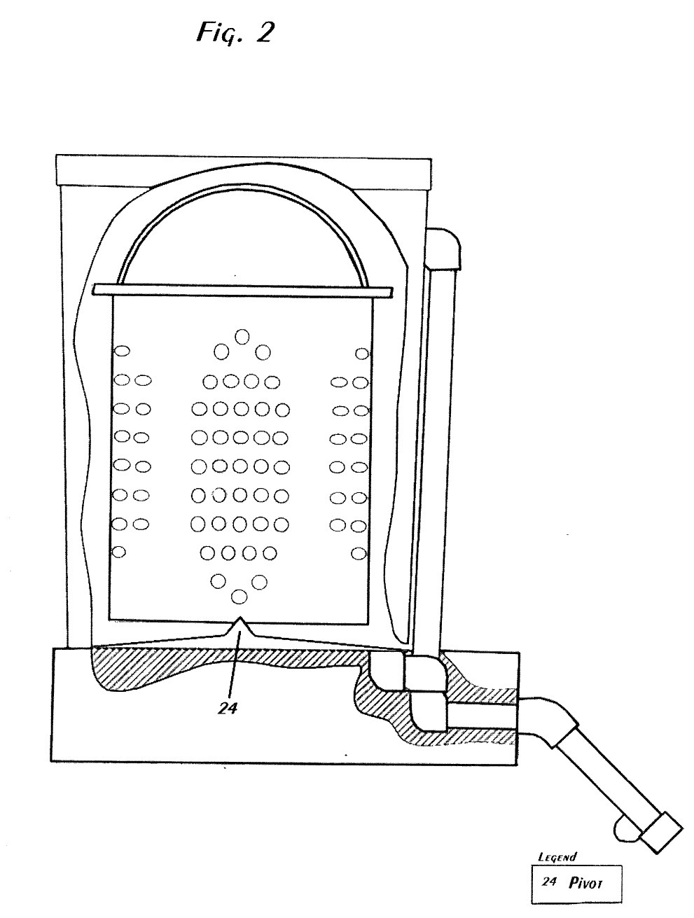

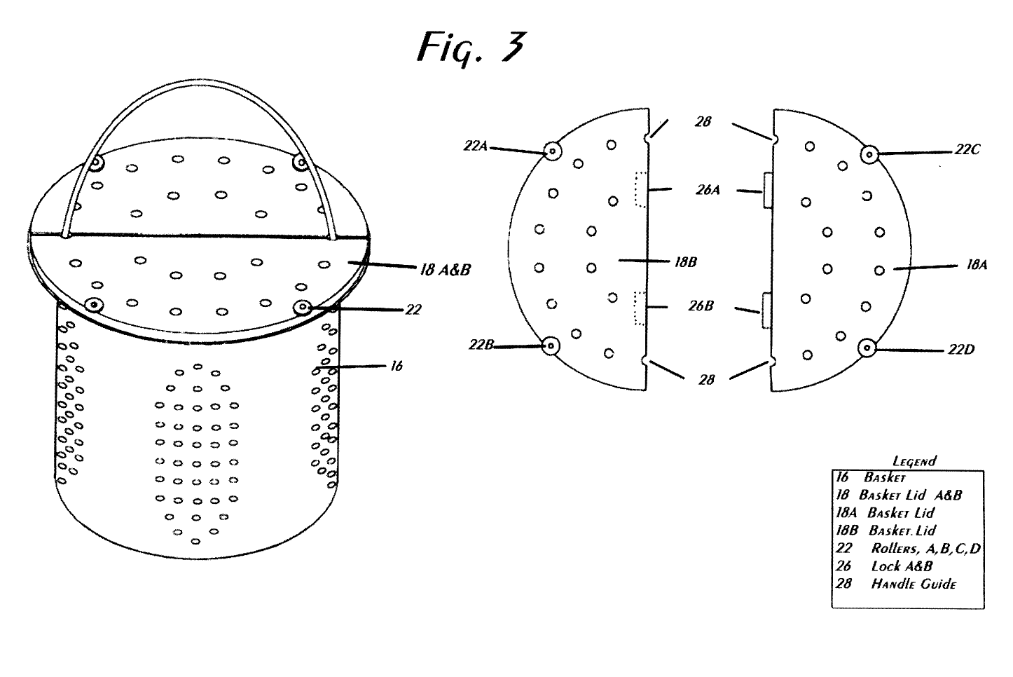

As illustrated in FIG. 1, and in accordance with our produce washer, the unit consists of two main components; Reservoir 4, and Base 12. FIG. 1 also depicts four associated components; Overflow Drain 6, Primary Drain 8, Waste Drain 10, and Water Inlet Coupling 14. Accordingly, FIG. 1 depicts four essential accessories; Sieved Basket 16, A&B Basket Lid 18 with permanent built in Roller(s) 22, Tethered Cap 21, and Total Cover Lid 20. Note: An additional necessity, although not shown in either FIG. 1, FIG. 2, or FIG. 3, concerns a standard faucet adapter with flexible tubing in sufficient length to connect from Water Inlet Coupling 14, to a cold-water source. Generally a kitchen faucet.

Reservoir 4, as shown in FIG. 1, is defined as a cylindrical water holding tank, with its floor, (a) dome shaped, and (b) slightly slanted toward Primary Drain 8. FIG. 1, also depicts Reservoir 4 as host to Basket 16, and its constant stream of cold tap water. In addition, FIG. 1 depicts Reservoir 4 as connected to Base 12 via Primary Drain 8. In defining Base 12, it is both (a) functional, and (b) cosmetic. As for its functionality, Base 12 is essentially a sturdy but hollow riser, designed to specifically add reinforcement to Reservoir 4. As for its cosmetic value, Base 12 conveniently conceals the conjoined area of the three aforementioned drains, thereby making the unit aesthetically pleasing to the eye.

As depicted in FIG. 1, Overflow Drain 6 connects to Reservoir 4, and there too is made aesthetically pleasing by means of a long hollow tube, permanently molded, onto, and parallel to, Reservoir 4. Likewise, this hollow tube is but a cosmetic conduit for Overflow Drain 6(s) waste water, and makes it initial connection through Reservoir 4(s) upper outer wall, ultimately ending at Base 12. As a result, Overflow Drain 6 serves dual purposes. Firstly, to prevent the overflow of Reservoir 4, and secondly, as the incoming water swirls in a circular motion, it rises to the level of Overflow Drain 6(s) opening, where it automatically skims away any floating debris, down its hollow tubing, and out through Waste Drain 10.

Accordingly, FIG. 1 depicts Overflow Drain 6(s) diameter of its opening, as twice the size of Water Inlet Coupling 14. Operationally, the size differential between Overflow Drain 6(s) opening, and its counterpart, Water Inlet Coupling 14 is crucial since it prevents the overflow of Reservoir 4. In fact, Water Inlet Coupling 14(s) smaller opening constricts the water flow, enough that its narrowed inlet enables standard water hook-ups to create the cyclonic action necessary for a thorough cleaning process.

Water Inlet Coupling 14 is the unit's designated water port, strategically located in the lower quarter of Reservoir 4. Externally, it can be seen as a standard male threaded fitting, while from an internal view, it can be seen as a restrictive elbow half the size of Overflow Drain 6(s) opening. This elbow sets at a 90-degree angle to Reservoir 4(s) inner wall, and is designed to route incoming tap water at such a rapid rate it creates the cyclonic action necessary to maintain the stability of Basket 16 within the vortex.

Accordingly, FIG. 1 depicts, Primary Drain 8, as being both identically sized to Water Inlet Coupling 14, and located flush to the bottom of Reservoir 4. As described earlier, Reservoir 4(s) floor is domed and slanted towards Primary Drain 8, thereby causing Primary Drain 8 to become gravity fed, which in turn is ideally suited for the continuous draw off of both heavy debris and the by now contaminated waste water. Note: In accordance with the produce washer, Primary Drain 8 feeds into Waste Drain 10 for the total evacuation of Reservoir 4. Waste Drain 10 generally empties into an adjacent sink, however other options will become apparent in the description of the Operation of the Main Embodiment.

As for the remaining essential accessories, and in accordance with the produce washer, FIG. 3 depicts the following items; Basket 16, A&B Basket Lid 18, Roller 22, A&B Lock 26, and two Handle Guide 28(s). Accordingly, Basket 16 is a removable aluminum sieved container, with a bow like curved handle designed to hold any such articles to be washed. Basket 16 is also used in conjunction with, A&B Basket Lid 18, which to is sieved and made up of a plasticized material. Each half houses two diagonally cut Handle Guide 28(s). These cuts have three functions; they (A) hold the handle of Basket 16 upright, (B) allow the two lid halves to lock via A&B Lock 26, and (C) prevent its floatage to the top of Reservoir 4. Each half also contains two tension rollers designated as Roller 22, A,B,C and D. These rollers ride on the inner wall of Reservoir 4 and stabilize Basket 16. Also illustrated in FIG. 3; Basket Lid 18 A has two male locking devices on its center cut, which fit into Basket Lid 8 B(s) female counterpart, and is designated as A&B Lock 26.

As shown in FIG. 2, Pivot 24 is located on the dome of Reservoir 4(s) floor and functions as Basket 16(s) centering point for the optional manual spin.

Standard Water Adapter 30 (not depicted in either FIGS. 1, 2, or 3) is an assembly consisting of a length of flexible tubing with a universal faucet quick disconnect, at one end, and a standard female fitting on the other. Its sole purpose is to distribute cold tap water to Water Inlet Coupling 14.

And lastly, Total Cover 20, as illustrated in FIG. 1, is a plastic dust cover put into place when the produce washer is no longer in use. It also serves cosmetic purposes, since it gives the unit a look of uniformity.

### PREFERRED EMBODIMENT—OPERATION

The main objective of our produce washer is to offer the public an easy yet thorough means of washing fresh fruits and vegetables, while at the same time following the government's guideline for safe food handling. Fortunately the Food and Drug Administration publishes easy to follow, yet definitive answers to the age-old question, “Does washing produce promote food safety?” To which they clearly respond, “Before eating or preparing, wash all fresh produce under cold running tap water to remove any lingering dirt.” This process also reduces any bacteria that may be present. However, it also recommends that if there is a firm surface, such as on apples or potatoes, they be scrubbed with a brush. “And,” they stress, “consumers should not use either soaps or detergents,” since one, they are not approved or labeled by the Food and Drug Administration for use on foods, and two, are apt to leave a soapy residue which not only tastes foul, but in some cases may cause an allergic reaction.

Besides the FDA, Peter Snyder, Jr., Ph. D., http:/glistserv.nal.usda.gov, has authored papers on the same subject, which clearly states, “If vegetables are correctly double washed in water, so that there is good dilution of the bacteria and the dirt on the surface of the vegetables, one can achieve a 100-to-1 reduction with each wash.” Therefore it stands to reason, if one can attain such an impressive ratio reduction after only one double hand washing, imagine the results using our mechanical apparatus which includes both, water friction cleaning, and a continuous dilution/reduction method that far exceeds either the FDA's or Dr. Snyder's guidelines. In fact, since our system is a self-contained unit, it operates without the usual fuss, muss and tedium, associated with the usual hand washing method. Yet, despite its ease of use, its appearance is sleek enough to remain out on any kitchen counter, while at the same time being a veritable workhorse in terms of achieving Dr. Snyder's 100-to-1 dilution factor.

Regarding the set up process; one simply connects Standard Water Adapter (not shown) 30 to its water source, which through its tubing routes all water directly into Water Inlet Coupling 14. The next step is just as easy, in that Waste Drain 10, the exterior waste line, be directed so that all wastage efficiently flows out to an adjacent sink. Once this set up is complete, the user simply loads sieved Basket 16 with unwashed produce, locks on A&B Basket Lid 18, and then places the entire assemblage into Reservoir 4.

The wash process begins by turning on the cold water, however it is suggested that Tethered cap 21 first be put into place by securing it snugly on the end of Waste Drain 10. This insures a more rapid initial fill of Reservoir 4 via Water Inlet Coupling 14. Moreover, this quick and forceful rush of continuous cold water not only free floats and rotates Basket 16 and its contents, but also creates the necessary friction to thoroughly wash the produce clean by the force of the water alone. Since according to the EPA, running water has an abrasive effect that soaking does not have. But even more importantly, the continuous exchange of clean, soap/free water passing in and out through Basket 16(s) sieve holes, not only dilutes, but in fact, far exceeds Dr. Snyder's 100-to-1 reduction ratio.

Subsequently, the wash process proceeds, and here to just as easily, since all that is left is for the removal of Tethered cap 21 as soon as the rush of incoming water reaches Overflow Drain 6, or its clearly marked fill level; thereby preventing the overflow of Reservoir 4. Note: This one time step is extremely important to Primary Drain 8, since it's initial rush of water is not unlike, “the opening of the flood gates.” Which in turn enables it (Primary Drain 8) to become not only gravity fed, but also an efficient means of routing away any heavy debris prone to settle on Reservoir 4(s) floor. Meanwhile, Overflow Drain 6 does the job it was designed for by skimming off lighter floating debris such as bird/animal droppings, insects and their larva, while at the same time evanescing away toxic chemical residuum generally found on either commercially or home grown produce. Typically, the wash cycle takes less then two minutes, since anything longer many cause, leafy vegetation and berries in particular, to become water logged. Hence the last step of the procedure is to shut off the water source, thereby allowing for any remaining water to vacate Reservoir 4 by way of Primary Drain 8, and Waste Drain 10.

Our system also has two optional procedures available; the first being its manual spin, whereby once Reservoir 4 is emptied, Basket 16 is positioned onto Pivot 24. From there the user simply grabs hold of Basket 16(s)handle, and then with a quick flick of the wrist, spins the basket to remove any excess water. Note: In especially leafy vegetation, two or even three spins may be necessary. The remaining option is a convenient presoak period, whereby during its initial fill, Tethered cap 21 is kept in place rather than removed. At this point the water is shut off, thereby allowing Reservoir 4 to remain full for the presoak period. It is up to the user's discretion to decide for how long, after which the unit is returned to its normal operation.

### CONCLUSIONS, RAMIFICATIONS, AND SCOPE

Accordingly it can be shown that our produce washer more than satisfies both the consumer's needs, and the Food & Drug Administration's guidelines for safe, food handling. Take for instance their strongly worded literature stressing the importance of thoroughly washing fresh fruits and vegetables before consumption. Which, when handled properly, is not only a messy process but also a time consuming one as well. And then some, if Dr. Peter Snyder's stringent 100-to-1 ratio reduction rule is added to the mix, or in other words not unlike what environmental scientists say, “The only solution to pollution is dilution.” However, there are several other reasons why our produce washer is far superior to hand washing. Namely it's convenience and ease of use, since washing produce the old fashioned way is hardly a task people look forward to performing. Especially when homemakers and professional food handlers alike, have to literally roll up their sleeves just in order to do the job correctly. In fact, with all the fuss and muss, people are more apt to leave their good intentions by the wayside settle for a series of quick rinses instead, thereby jeopardizing not only their, but their families good health.

However, another reason why our rapid cold-water exchange is vital, are the live and often times microscopic insects that infest any number of produce. Take Spider Mites (http://www.ag.ohio-state.edu/˜ohioline/) for instance. They commonly infest vegetation such as; beans, tomatoes, eggplant, cucumbers, various lettuces and celery to mention only a few. Informatively speaking, Spider Mites are usually red, yellow or green, about 1/50 inch and have four pairs of legs. The body is oval. Adults lay their eggs on plants, which in turn, then hatch into young mites.

Accordingly, Associate Professor David J. Shetlar (s-mail:OSU Entomology Extension Building, 1991 Henny Road, Columbus, Ohio 43210) describes Spider Mites as having tiny mouthparts that are modified for piercing individual plant cells and removing the contents. He also points out; they are easily detected by taking a piece of white paper or cardboard, and striking some plant foliage on it. The mites can be seen walking slowly on the paper. He also concludes they (the mites) lock onto vegetation by means of their piercing mouthparts, and with such intensity they easily withstand anything but a series of aggressive cold water flushes. What's more, we contend through repeated testing, that the only logical solution for ridding the mites, or for that matter any other form of insect, is to wear down their resistance with a continuous stream of extremely cold water. Note: We do not contend that our produce washer alters the temperature of incoming water in any way, since anytime a cold-water tap is left open, extremely cold water eventually follows. However, extreme coldness can be problematic for people suffering from arthritis and cold sensitivity. Therefore grandma's hand dipping method may prove difficult. But fortunately, our produce washer allows the user the ability to thoroughly clean produce without even getting their hands wet!

Something else worth mentioning is that the FDA has never approved anything but clean water to wash produce. In fact we agree, since with our system there is absolutely no need for soaps, detergents or even the new citrus/baking soda based cleaners now being touted by any number of manufacturers.

Although the description above contains multiple specificities, they should not be construed as limiting the scope of the invention but as merely providing illustrations of some of the presently preferred embodiments of this invention. Various other embodiments and ramifications are possible within it's scope. Thus the scope of the invention should be determined by the appended claims and their legal equivalents, rather than by the examples given.

What is claimed is:

1. An apparatus that is non electric and designed to use fluidic means to create water friction which rids undesirable residue from food particles.
a) The apparatus of claim 1 is comprised of a water holding tank with a convex floor which can be tailored to varying sizes and portability and permanency.
b) The holding tank in claim 1(a) is inclusive of an inlet coupling located in the lower portion of said tank and set at a specific angle as to create cyclonic motion of the incoming water by means of a standard water adapter.
c) Also inclusive in said holding tank are three conjoined drains of a specific size as to allow proper drainage.
d) The convex floor in claim 1(a) has a centering pivot to aid in the manual spin process
e) The apparatus of claim 1 includes a cosmetic lid which covers said holding tank when the apparatus is not in use

2. The apparatus of claim 1 is further characterized as having a removable sieved container for housing food articles to be cleaned.
a) The container of claim 2 is defined as a handled sieved basket sized to fit within said holding tank of claim 1(a).
b) Said basket is inclusive of a removable lid.
c) The lid of claim 2(b) is defined as a two part sieved cover with built in locking means in each half and inclusive with handleguides for said basket in claim 2(a).
d) Said lid of 2(b) is also characterized as having tension devises for stabilizing and assisting in the manual spin process.

3. The apparatus of claim 1 is also inclusive of a base.
a) Said base is defined as a stabilizing riser which the apparatus of claim 1 is secured upon by means of conjoined drains concealed within.
b) Said base also serves a cosmetic function since it gives the apparatus of claim 1 a look of uniformity which is more esthetically pleasing to the eye.
